(19) United States
(12) Patent Application Publication
(10) Pub. No.: US 2007/0226747 A1
(43) Pub. Date: Sep. 27, 2007

(54) Method of task execution environment switch in multitask system

(76) Inventor: Keita Kobayashi, Osaka (JP)

Correspondence Address: MCDERMOTT WILL & EMERY LLP, 600 13TH STREET, NW, WASHINGTON, DC, 20005-3096, US

(21) Appl. No.: 11/723,576

(22) Filed: Mar. 21, 2007

(30) Foreign Application Priority Data
Mar. 23, 2006 (JP) 2006-080330

(51) Int. Cl. G06F 9/46

(52) U.S. Cl. 718/108

(57) ABSTRACT

A task execution environment switching method in a multitask system, which comprises the steps of: a first step for evacuating current task execution environment information in a stack-exclusive-use execution environment stack to a context evacuating region, as pre-processing for calling processing of a sub-function from a main function within the task; a second step for storing execution environment information of the sub-function in a execution environment stack for function of the task from an execution environment table of the task; a third step for calling the sub-function from the main function within the task; and a fourth step for storing the task execution environment information evacuated in the context evacuating region in the first step in a task of the task-exclusive-use execution environment stack, when processing is returned from the sub-function to the main function.

### BACKGROUND OF THE INVENTION

1. Field of the Invention

The present invention relates to a switching method of task execution environment information in multitask OS (Operating System) and, more specifically, to a technique for sharing a stack memory with a plurality of tasks and for performing exclusive access control of other CPU resources.

2. Description of the Related Art

FIG. 6 is a flowchart showing a processing method of a multitask system according to a conventional technique. In this conventional technique, a plurality of tasks is made to share the same stack region. With respect to the individual common stack region, allocation of the tasks to the common stack region is exclusively controlled in units of the execution start of the task to the end thereof. The distinctive feature is that the unit of allocating the processing in sharing the stack memory between the tasks is set as “from the execution start of the task to the end of it”.

Referring to FIG. 6, description will be given to the stack control operation in a multitask processing system according to a conventional technique that is disclosed in Japanese Published Patent Literature (Japanese Unexamined Patent Publication 6-168145). When there is a request for executing a task, first, it is judged in step S41 whether or not a stack region is used by other task that shares the stack region. When it is judged as a result that the other task is not using the stack region, the processing is shifted to step S42 where the task is set executable. Meanwhile, when it is judged that the other task is using the common stack region, the processing is shifted to step S43 where the transition of the task to the executable state is delayed. Herewith, the memory-use efficiency of the common stack region can be improved.

The operating system of the above-described conventional technique has a stack managing function for allocating a single stack region to a plurality of tasks that have the same priority. Therefore, the single stack region is shared by the plurality of tasks that have the same priority. However, it is assumed that the plurality of tasks that commonly utilize the single region are not executed simultaneously, and the execution order of the tasks can be determined in advance. For example, in the case where three tasks A, B, and C share a single stack region, it can be set so that the task B is executed after the execution of the task A is ended, and the task C is executed after the execution of the task B is ended. That is, the common stack region is allocated only to a single task that is to be executed exclusively. Further, it is also possible to allocate a single task region for a single task as exclusive use thereof. For example, when ten tasks are managed, the OS allocates an exclusive-use stack region for each of two tasks, allocates a single common stack region for four tasks that have the same priority, and allocates a single common stack region to other four tasks that have the same priority. As a result, it becomes total of four stack regions though there are the ten tasks. Thus, it is possible to achieve the relation of m<n, where the total number of the tasks is n (n is a positive integer) and the total number of stack regions is m (m is a positive integer). Therefore, it is possible to decrease the proportion of the entire stack regions for the entire memory capacity of a RAM (Random Access Memory). As a result, it becomes possible to mount the multitask OS program to a single-chip computer where storage capacity of built-in RAM is limited.

However, the above-described conventional technique has a following issue, since the unit for allotting the processing in sharing the stack memory with the plurality of tasks is set as “from the execution start of the task to the end thereof”. For example, it is not possible to share the task stack region in the case where there is a possibility of performing a communication in the middle of the task processing, e.g. in calling a sub-function from a main function, or in the case of performing processing between a plurality of tasks that may start simultaneously. In such cases, it is necessary to be secured individually with respect to the stacks used for the exclusive processing and the processing of other tasks. Therefore, it is not possible to reduce the memory.

### SUMMARY OF THE INVENTION

The main object of the present invention therefore is to achieve sharing of the task stack region even in the case where there is a possibility of performing a communication in the middle of the task processing, e.g. in calling a sub-function from a main function, or in the case of performing processing between the tasks that may start simultaneously, so as to reduce the amount of the memory used in the entire system.

In order to solve the aforementioned issues, the task execution environment switching method in a multitask system according to the present invention comprises the steps of:

a first step for evacuating a current task execution environment information in a execution environment stack exclusive for task to a context evacuating region, as preprocessing for calling processing of a sub-function from a main function within the task;

a second step for storing execution environment information of the sub-function in an execution environment stack for function of the task from an execution environment table of the task;

a third step for calling the sub-function from the main function within the task; and

a fourth step for storing the task execution environment information evacuated to the context evacuating region in the first step in an execution environment stack for function of the task, when processing is returned from the sub-function to the main function.

In the present invention, a plurality of the tasks shares a stack region as a single unit consisting of the start of the function until the end of the function. In this respect, the present invention is different from the case of the conventional technique in which the stack region is shared as a unit consisting of from the execution start of a task up until the end thereof. Therefore, it is possible in the present invention to share the stack between the tasks by a function unit that is smaller than a task unit.

Specifically, an exclusive execution environment stack is allocated to each task managed by an OS, while a common execution environment stack for function is allocated as a single unit consisting of the start of the function until the end thereof. When there is a request for calling a sub-function, it is judged whether or not the common execution environment stack for function is being used. When it is judged that it is being used, the task is shifted to an execution standby state. When it is judged that it is not being used, the current task execution environment information is evacuated to the context evacuating region, the common execution environment stack for function allocated to the sub-function is set as “in use”, the execution environment information of the sub-function is substituted to the execution environment stack for function, and the sub-function is called by using it. When the processing is returned from the sub-function, the evacuated task execution environment information is substituted to the execution environment stack exclusive for task to be returned to the task execution environment information of right before calling the sub-function.

As a result, it is possible according to the present invention to perform sharing of the stack region even in the case where there is a possibility of performing communication in the middle of the task processing, or even between a plurality of tasks that may start simultaneously. Accordingly, the amount of the memory used in the entire system can be reduced.

There is such an embodiment that the present invention further comprises the steps of:

right before the second step, a step for changing the task execution information in the execution environment table to an exclusive state to be used exclusively from other tasks; and

right after the fourth step, a step for releasing the exclusive state.

There are further a few embodiments with respect to the aforementioned embodiment. In one of them, after it is judged in the first step whether or not a flag is set for indicating that another task provided in each task execution environment information in the execution environment table is in use, the task is shifted to a standby state in the first step when it is judged that the flag is being set;

when it is judged in the first step that the flag is not being set, the flag is set in the step for changing to the exclusive state to change the task execution information in the execution environment table to the exclusive sate; and

the exclusive state is released by clearing the flag in the step for releasing the exclusive state. In this case, when the flag is being set in the first step, an error is returned without calling the sub-function.

In another embodiment, the step for making the transition to the exclusive state is executed by changing the state to a task dispatch inhibited state; and

the step for releasing the exclusive state is executed by changing the state to a task dispatch permitted state. Dispatch herein means allocation (scheduling) of the CPU for a plurality of tasks that are processed by the OS.

In yet another embodiment, the step for making the transition to the exclusive state is executed by changing the task to an interruption inhibited state; and

the step for releasing the exclusive state is executed by changing the task to an interruption permitted state.

Otherwise, the step for shifting to the exclusive state may be executed by changing the task to a CPU lock state that fundamentally restrains the dispatch and interruption.

In the above-described embodiment utilizing the shift to the exclusive state, it is unnecessary to check the sub-function calling and shift the task to the standby state. Thus, the processing efficiency becomes high.

Additionally, in the present invention, there is also an embodiment wherein the task execution environment is a stack register, and the task execution environment information is a stack region address used in the sub-function. Furthermore, there is also such an embodiment that the context evacuating region indicates a stack region address.

According to the present invention described above, it is possible to share the stack region between the plural tasks by a function unit that is smaller than a task unit. Thus, the amount of the memory used in the entire system can be reduced. Therefore, it becomes possible to operate a multitask system with a memory of a small capacity.

The present invention is a method for switching task execution environment in a multitask system, which enables sharing of the stack region even in the case where there is a possibility of performing communication during the task processing, or even between a plurality of tasks which may start simultaneously. Therefore, the present invention is effective as a technique for reducing the amount of the memory used in the entire system.

### BRIEF DESCRIPTION OF THE DRAWINGS

Other objects of the present invention will become clear from the following description of the preferred embodiments and the appended claims. Those skilled in the art will appreciate that there are many other advantages of the present invention by embodying the present invention.

FIG. 1 is a block diagram showing the structure of a multitask system in a first embodiment of the present invention;

FIG. 2 is a flowchart of the processing for calling a sub-function from a main function in the first embodiment of the present invention;

FIG. 3 is a flowchart of the sub-function call check processing in the first embodiment of the present invention;

FIG. 4 is an illustration showing how a stack region is used when a context evacuating region indicates the sub-function execution environment information in the first embodiment of the present invention;

FIG. 5 is a flowchart of the processing for providing the exclusive state when calling a sub-function from a main function in a second embodiment of the present invention; and

FIG. 6 is a flowchart illustrating an exclusive control of a common stack region according to a conventional technique.

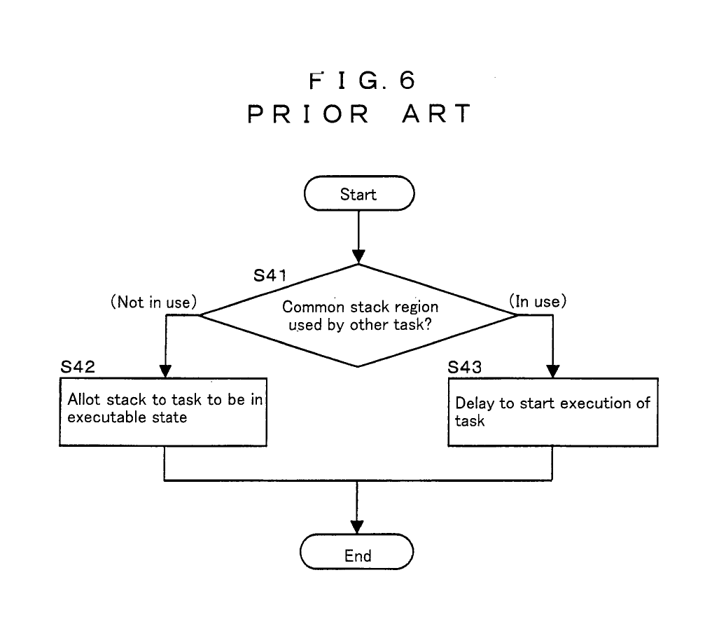

### DETAILED DESCRIPTION OF THE INVENTION

Hereinafter, with respect to the preferred embodiments of the present invention, embodiments of the task execution environment switching method in a multitask system will be described in detail referring to the accompanying drawings.

### First Embodiment

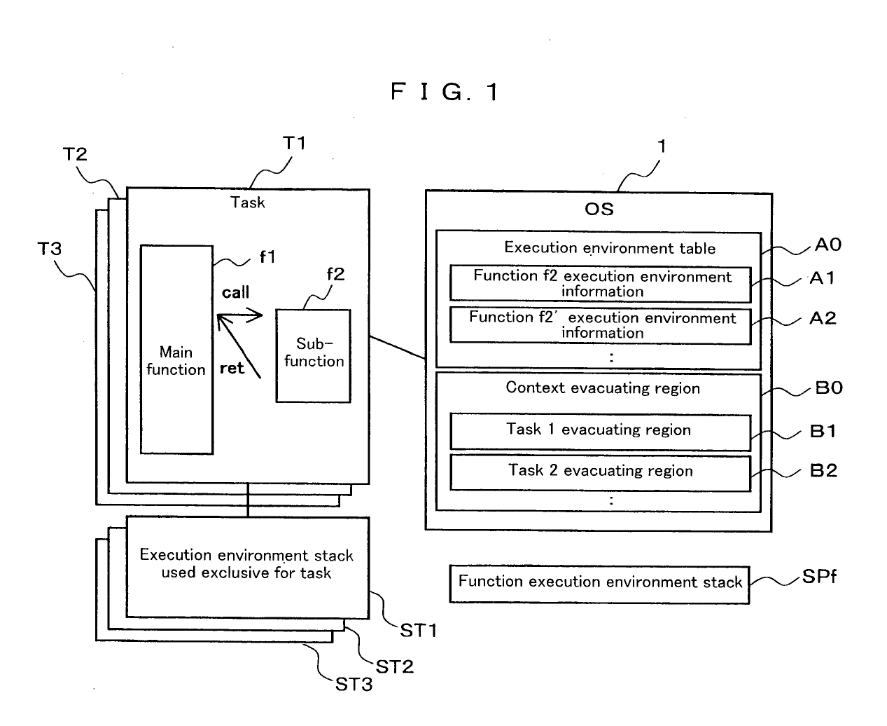

FIG. 1 is a block diagram showing the structure of a multitask system according to a first embodiment of the present invention. In this multitask system, an operating system (OS) 1 manages a plurality of tasks Ti (i=1, 2, - - - n) in parallel, and controls the executions thereof. Each of the tasks Ti comprises a respective stack STi (i=1, 2, - - - n) as the execution environment for exclusive use. In the task T1, a main function f1 calls a sub-function f2.

The operating system 1 comprises an execution environment table A0 and a context evacuating region B0. The execution environment table A0 contains execution environment information for sub-function f2 A1, sub-function f′2 execution environment information A2, - - - . The execution environment information for sub-function f2 A1 stores an address value of an execution environment stack that is used when the task T1 executes the sub-function f2. The context evacuating region B0 includes a task T1 evacuating region B1, a task T1 evacuating region B2, - - - . These task evacuating regions are the regions for evacuating the current stack register value before changing the task-exclusive-use execution environment stack ST1 that is a stack register. At least one of the sub-function execution environment information and the task evacuating region may be provided respectively. SPf is an execution environment stack for the function.

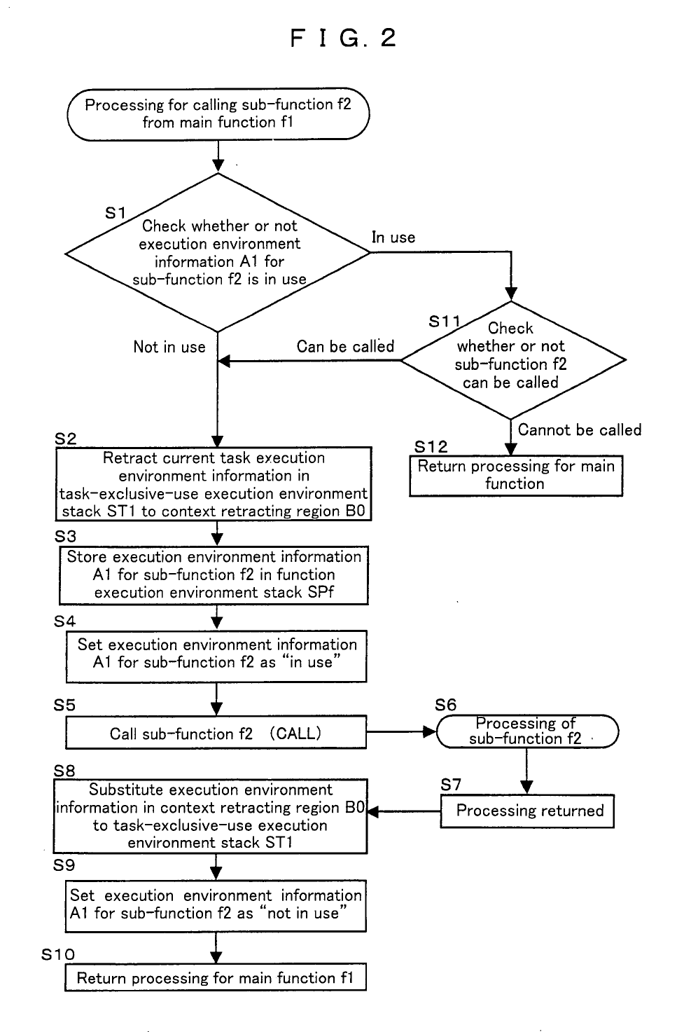

FIG. 2 is a flowchart showing the processing procedure for calling a sub-function from a main function in the first embodiment of the present invention. First, in step S1, it is checked whether or not the execution environment information for sub-function f2 A1 in the execution environment table A0 is “in use”. When it is confirmed that it is not used, the processing is shifted to step S2. When it is confirmed that it is being used, the processing is shifted to step S11.

In step S2, the current task execution environment information in the task-exclusive-use execution environment stack ST1 is evacuated to the task T1 evacuating region B1 of the context evacuating region B0 so as to save it.

Then, in step S3, the execution environment information for sub-function f2 A1 in the execution environment table A0 is stored in the execution environment stack for function SPf that is a stack register. This is a preparation for executing the sub- function f2.

Then, in step S4, the execution environment information for sub-function f2 A1 in the execution environment table A0 is set as “in use”. A flag may be set for making the execution environment information A1 to be “in use”. For example, it can be set as “in use” by setting the lowest bit of the execution environment information A1 in the execution environment table A0 (array variables) as “1”, and set as “not in use” by setting the lowest bit as “0”.

Then, in step S5, the sub-function f2 is called, and the processing of the sub-function f2 is started in step S6. When the processing of the sub-function f2 is ended, it is detected in step S7, and the processing is returned form the sub-function f2 to the main function f1.

Then, in step S8, the execution environment information that is evacuated in the task T1 evacuating region B1 of the context evacuating region B0 in the earlier step S2 is substituted to the task-exclusive-use execution environment stack ST1.

Then, in step S9, the execution environment information for sub-function f2 A1 in the execution environment table A0 is set as “not in use”. For example, the lowest bit of the execution environment information A1 is set as “0” for setting it as “not in use”. When it is set as “not un use”, a standby task of the execution environment information for sub-function f2 is searched if necessary. If there is a standby task, it is necessary to release the standby state of the task. The detailed processing thereof is not described herein. At last, the processing is returned to the main function f1 in step S10.

Meanwhile, when it is judged in step S1 that the execution environment information for sub-function f2 A1 in the execution environment table A0 is set as “in use”, the processing proceeds on to step S11 where it is checked whether or not the sub-function f2 can be called. When it is judged that the sub-function f2 can be called, the processing is shifted to step S2. When it is judged that it cannot be called, the processing proceeds on to step S12 to return the processing to the main function f1.

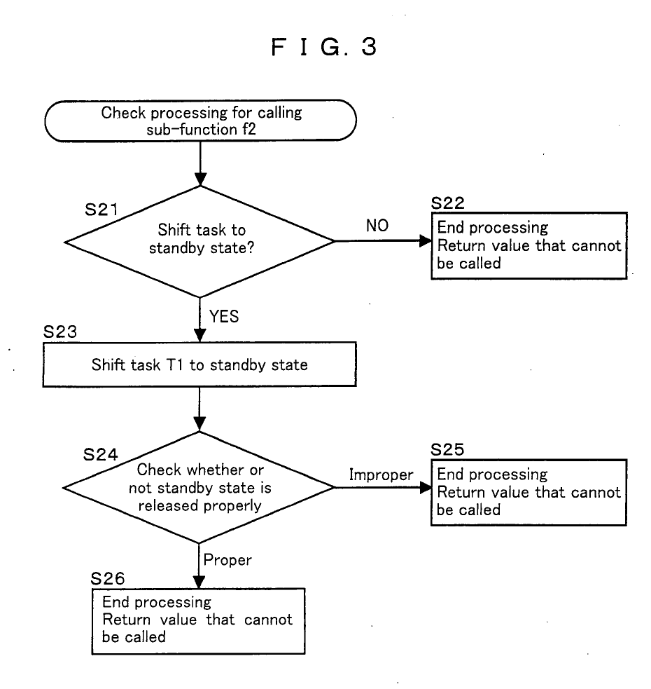

FIG. 3 is a flowchart showing the procedure for checking whether or not the sub-function f2 can be called. This procedure will be described hereinafter. First, in step S21, it is checked whether or not the task is shifted to the standby state. When it is confirmed that task is not shifted to the standby state, the processing is transferred to step S22. When it is confirmed that that task is shifted to the standby state, the processing is transferred to step S23. As a specific example of the processing of step S21, there is such processing, for example, wherein, when the value of a specific variable within a certain OS is “1”, the task is shifted to the standby state and, when the specific variable is “0”, the task is not shifted to the standby state.

When it is confirmed in step S21 that the task is not shifted to the standby state, the processing proceeds on to step S22 to execute the processing, and return a value that cannot be called. Meanwhile, when it is confirmed in step S21 that the task is shifted to the standby state, the processing is shifted to step S23.

In step S23, the task T1 is shifted to the standby state. At this time, the execution environment information for sub-function f2 A1 is set in the use standby state, connected to a standby cue within the OS, while changing the state variable of the task T1 and performing the transition processing to another task managed within the OS. The details of the transition processing to the standby state are not described herein.

When task T1 is shifted to the standby state in step S23 and the standby state is released due to some reasons, the processing is shifted to step S24. It is checked in step S24 whether or not the standby state is released properly. When it is confirmed that it is released properly, the processing is shifted to step S26. However, when it is confirmed that it is released improperly, the processing is shifted to step S25. Whether the standby state is released properly or not can be judged as follows, for example, that is, it can be judged that the standby state is released properly, when it is confirmed that the use of the execution environment information for sub-function f2 A1 by another task is ended and the information A1 is released. Meanwhile, it can be judged that the standby state is released improperly, when it is confirmed that the standby state of the task 1 is released by a request for forced standby release or the like.

When it is confirmed in step S24 that the standby state is released improperly, the processing is shifted to step S25. The termination processing is performed and the value that cannot be called is returned in step S25.

When it is confirmed in the check processing of step S11 that the sub-function cannot be called, the processing is shifted to step S12. That is, it is returned to the processing of the main function f1. At that time, it is necessary to inform the main function f1 that the sub-function f2 cannot be called. Thus, it is informed to the main function f1 by returning an error value, for example. When it is confirmed in the check processing of step S11 that the function can be called, the processing is shifted to step S2. The processing on and after step S2 in this case is carried out in the manner described above.

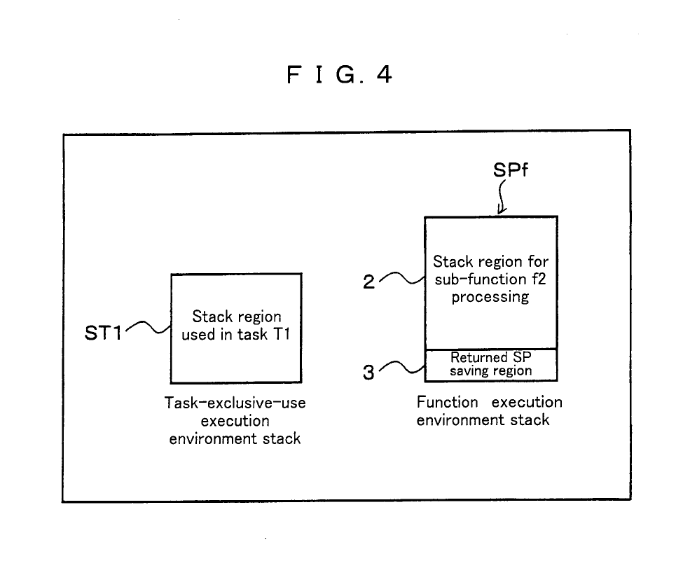

A usage of the execution environment stack for function SPf will be described referring to FIG. 4, in the case where the context evacuating region B0 indicates a value “(SP)+4” of the execution environment information for sub-function f2 A1. In this case, the value of the execution environment information for sub-function f2 A1 indicates the sub-function execution processing stack region 2, and a returned SP saving region 3 indicates the value “(SP)+4” of the execution environment information for sub-function f2 A1. The last address used in the task T1 is saved in the returned SP saving region 3 of the stack region for the sub-function f2.

As described above, in the embodiment, the tasks share the stack region by making the start of the function until the end thereof to be a single unit. Since the stack is shared between the tasks based on a function unit that is smaller than the task unit, it is possible to share the stack region even in the case where there is a possibility of performing communication in the middle of the task processing, or even between the tasks that may start simultaneously. Therefore, the amount of the memory used in the entire system can be reduced.

### Second Embodiment

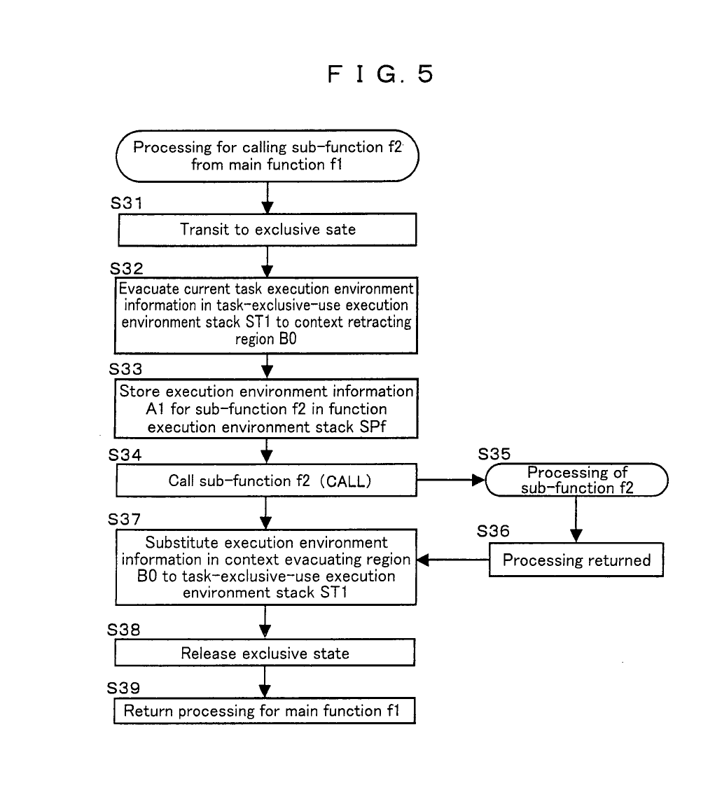

FIG. 5 shows a flowchart of the processing for calling the sub-function f2 from the main function f1 in a second embodiment of the present invention. The processing of this embodiment shown in FIG. 5 is different from the processing (FIG. 2) of the first embodiment in terms of the following respect. That is, the second embodiment performs the processing for making the transition to the exclusive state in step S31 and performs the processing for releasing the exclusive state in step S38, instead of the processing of step S4 to set a flag for indicating that it is in use and the processing of step S9 to set a flag for indicating that it is not in use. This will be described in detail hereinafter.

First, in step S31, it is shifted to an exclusive state. The exclusive state means a task dispatch inhibited state, interruption inhibited state, or CPU lock state, for example.

Then, in step S32, the current task execution environment information in the task-exclusive-use execution environment stack ST1 is evacuated to the task T1 evacuating region B1 of the context evacuating region B0 so as to save it.

Then, in step S33, the execution environment information for sub-function f2 A1 in the execution environment table A0 is stored in the execution environment stack for function SPf. Then, the sub-function f2 is called in step S34, and the processing of the sub-function f2 is started in step S35. When the processing of the sub-function f2 is ended, it is detected in step S36 and the processing is returned from the sub-function f2 to the main function f1.

Then, in step S37, the execution environment information that is evacuated in the task T1 evacuating region B1 of the context evacuating region B0 in step S32 is substituted to the task-exclusive-use execution environment stack ST1.

Then, the exclusive state is released in step S38. In the case where it is set precedently in the step S31 to a task dispatch inhibited state, the task is set to a task dispatch permitted state in releasing processing of the exclusive state (step S38). Further, when it is set precedently in the step S31 to an interruption inhibited state, the task is set to an interruption permitted state in releasing processing of the exclusive state (step S38). Furthermore, when it is set precedently in the step S31 to a CPU lock state, the CPU lock state is released in releasing processing of the exclusive state (step S38).

After performing the above-described processing of step S38, the processing is returned to the main function f1 in step S39 at last.

As described above, in this embodiment, the tasks share the stack region by making the start of the function until the end thereof to be a single unit. Since the stack is shared between the tasks with a function unit that is smaller than a task unit, it is possible to share the stack region even in the case where there is a possibility of performing communication in the middle of the task processing, and even between the tasks that may start simultaneously. Therefore, the amount of the memory used in the entire system can be reduced. In addition, the processing shown in FIG. 2 for checking whether or not the sub-function can be called is not necessary and there is no shift to the task standby state, which provides high processing efficiency.

### Third Embodiment

n the first embodiment and the second embodiment described above, the execution environment information for sub-function f2 A1 is made to be the execution environment information. Instead, it may be structured to make the sub-function execution environment information A1 to be an operation mode of the CPU, and evacuate the operation mode in execution of the main function f1 to the context evacuating region B0 in order to save it during the processing for calling the sub-function f2 from the main function f1, so as to switch the CPU operation mode of the sub-function f2.

Further, in the case of a multiprocessor with a plurality of CPUs, it may be constituted in such a manner that a specific CPU is designated in the execution environment information for sub-function f2 A1, and the CPU to be used is switched in the processing for calling the sub-function f2 from the main function f1.

The present invention has been described in detail referring to the most preferred embodiments. However, various combinations and modifications of the components are possible without departing from the spirit and the broad scope of the appended claims.

What is claimed is:

1. A task execution environment switching method in a multitask system, comprising the steps of:
a first step for evacuating current task execution environment information of a task-exclusive-use execution environment stack to a context evacuating region, as pre-processing for calling processing of a sub-function from a main function within said task;
a second step for storing execution environment information of said sub-function in a execution environment stack for function of said task from an execution environment table of said task;
a third step for calling said sub-function from said main function within said task; and
a fourth step for storing said task execution environment information evacuated to said context evacuating region in said first step in a task of said task-exclusive-use execution environment stack, when processing is returned from said sub-function to said main function.

2. The task execution environment switching method according to claim 1, further comprising the steps of:
just before said second step, a step for transferring said task execution information in said execution environment table to an exclusive state to be used exclusively from other tasks; and
just after said fourth step, a step for releasing said exclusive state.

3. The task execution environment switching method according to claim 2, wherein:
in said first step, it is judged whether or not a flag is set for indicating that another task provided in each task execution environment information in said execution environment table is in use and, said task is shifted to a standby state in said first step when it is judged that said flag is being set;
when it is judged in said first step that said flag is not being set, said flag is set in said step for transferring to said exclusive state to transfer said task execution information in said execution environment table to said exclusive sate through setting said flag in said step for transferring to said exclusive state; and
said exclusive state is released by clearing said flag in said step for releasing said exclusive state.

4. The task execution environment switching method according to claim 2, wherein:
said step for making the transition to said exclusive state is executed by changing a task to a task dispatch inhibited state; and
said step for releasing said exclusive state is executed by changing a task to a task dispatch permitted state.

5. The task execution environment switching method according to claim 2, wherein:
said step for making the transition to said exclusive state is executed by changing a task to an interruption inhibited state; and
said step for releasing said exclusive state is executed by changing a task to an interruption permitted state.

6. The task execution environment switching method according to claim 1, wherein:
said task execution environment is a stack register; and
said task execution environment information is a stack region address used in said sub-function.

7. The task execution environment switching method according to claim 1, wherein said context evacuating region indicates a stack region address.
